(19) United States
(12) Patent Application Publication
(10) Pub. No.: US 2006/0070110 A1
(43) Pub. Date: Mar. 30, 2006

(54) Apparatus and method for remote camera operations

(76) Inventor: Jeff Mercer, Mangham, LA (US)

Correspondence Address: CHALKER FLORES, LLP, 2711 LBJ FRWY, Suite 1036, DALLAS, TX, 75234, US

(21) Appl. No.: 11/214,335

(22) Filed: Aug. 29, 2005

Related U.S. Application Data
(60) Provisional application No. 60/613,959, filed on Sep. 28, 2004.

(51) Int. Cl. H04N 7/173; H04N 7/18; H04N 9/47

(52) U.S. Cl. 725/105; 348/143

(57) ABSTRACT

The present invention includes device, system, method of using and making a surveillance apparatus including a single image event activated detection module configured to collect data and a communication unit operably connected to the capture module to communicate with a remote central monitoring unit.

### CROSS REFERENCE TO RELATED APPLICATIONS

This application claims priority to U.S. Provisional Application Ser. No. 60/613,959, entitled “Apparatus and Method for Remote Camera Operations,” filed Sep. 28, 2004, the contents of which are incorporated by reference herein in their entireties.

### TECHNICAL FIELD OF THE INVENTION

The present invention relates in general to the field of remote surveillance and, more particularly, to devices, systems and methods for interactive wireless remote surveillance, wherein a command unit is capable of communication with and controlling the surveillance system located at a remote location.

### BACKGROUND OF THE INVENTION

Without limiting the scope of the invention, its background is described in connection with remote surveillance systems used in the observation of locations that were routine maintenance is inconvenient or impractical due to location or placement of the surveillance system, as an example.

Heretofore, in this field, it is sometimes desirable for a user to take a picture when they are not present. For instance, the user may want to keep surveillance on a remote location for security or surveillance reasons or to monitor animals in their natural habitat. However, systems currently available for providing surveillance and/or security for such areas have limitations, which may not be desirable for the operator.

The current remote surveillance systems require routine maintenance, which includes replacing the power supply, transferring data form the surveillance systems so that it may be viewed or stored, replenishing the film or other media, resetting operating parameters and similar operations. In some instances, an event (e.g., tree branch movement, wind, rain or animals) may cause the system to repeatedly respond, which depletes resources (e.g., film, batteries, and the like) that must be replaced by the user. However, in some instances it may be inconvenient and impractical for the user to return to the surveillance system to perform routine maintenance due to its remote location (e.g., remote caves, treetops, remote wooded area, inaccessible geographic area, restricted areas and the like).

Additionally, remote surveillance systems are often used to observe animals in their natural surroundings (e.g., scientific research, animal behavioral studies, animal tracking and the like). However, routine maintenance at such locations is also impractical as the invasion of the user into the habitat to perform the maintenance would disrupt the normal activities of the indigenous population and leave traces of human presence, e.g., odors, tracks, debris and the like.

As a consequence of the foregoing, a longstanding need exists among users for a method and apparatus that allows surveillance of remote locations and requires little or no routine maintenance, while being capable of remotely communicating with the user.

### SUMMARY OF THE INVENTION

In accordance with the present invention, a method, system and apparatus are provided that allows the surveillance of remote locations while being capable of remotely communicating with the user and requires little or no routine maintenance. The present invention provides a surveillance apparatus for monitoring remote locations while maintaining contact with a remotely located central monitoring unit.

For example, the surveillance apparatus for monitoring remote locations having a single image event activated detection module configured to collect data and operably connected to a communication unit that is in communicate with a remote central monitoring unit. The surveillance apparatus also includes a power module having a battery source in electrical communication with a solar panel for storage of energy generated by the solar panel, wherein the battery source independently powers the single image event activated detection module and the communication unit.

The single image event activated detection module may be configured to detect any type of event the user wishes to monitor. The detection module may be a simple motion detector, detecting movement in the surrounding area or a more sophisticated detector able to discriminate based on degree of movement or size of the animal moving. Additionally, other types of detectors may be used. For example, detector modules may be configured to detect the heat emitted by an animal or object and adjusted to activate the collection of data when a certain level of heat emissions is reached, e.g., the heat emitted by a rat as opposed to that of a deer or a car. The detector modules may also be configured to detect light or sound allowing the collection of data in response to lights being turned on or off, the lights or sound of an automobiles arriving or departing, the sound of animals or people at the monitoring site. Additionally, detection modules may be used to observe the effects of environmental conditions at the remote location by the activation of the system when certain conditions are met like specific temperatures, wind speeds, rainfall or humidity levels. The above-mentioned detection module may be combined in a variety of combinations as needed by the user for a particular situation. Typical methods known to those of skill in the art may be used in the detection module such as a photoelectric beam, an infrared beam, a laser beam, a microwave beam, a visible light beam, a UV beam, motion or combinations thereof.

The surveillance apparatus of the present invention is configured to collect data in response to activation. The data may be collected in a variety of formats depending on the type of detection module used. In one embodiment, the detection module may be a still photographic camera of any of the formats available, allowing the collected data to be in the form of a negative or photograph. Although negative or photograph data are not the preferred form of data, the communication will provide an indication to the user of activity at the location, indications of low resources, indications of malfunctions and combinations thereof. A digital camera may also be used as the detection module allowing the collection of the data on a multimedia format, e.g., rewriteable storage media, magnetic storage media and the like. Other detection module may also be used such as an analog camera, an IR camera, a night vision camera, a microphone allowing storage in the appropriate format for the type of detection module. Additionally combinations of the different detection module may be used as needed by the user for a specific application.

The surveillance apparatus of the present invention includes a communication unit that is in communication with a remote central monitoring unit. The communication between the communication unit of the surveillance apparatus and the remote central monitoring unit may be established in a variety of manners and may use transmission protocols that are known to persons of ordinary skill in the art. In some instances, the protocols may be encrypted to supply additional security for certain applications. The method of communication may be through a wireless modem, e.g., a wireless modem, a RF modem, a satellite modem, a broadband modem. The communications unit may also incorporate an identification code or stamp (ID stamp) into the signal to indicate a specific time, date or surveillance apparatus. The ID stamp will allow identification of individual surveillance apparatus connected on a network. The ID stamping may also be accomplished using a modem having a RF-ID communication device. Other methods of communication may be used to link the remote surveillance apparatus with the remote central monitoring unit, e.g., laser communication modules, IR communication modules ultrahigh frequency modules, microwave communications and the like. Additionally, the communications unit may include a combination of the above-mentioned modems and other communication devices known to persons of skill in the art.

For example, in one embodiment the communication unit is a transceiver. As used herein a transceiver is a combination transmitter and/or receiver in a single package and applies to wireless communications devices, e.g., cellular telephones, cordless telephone sets, handheld two-way radios, and mobile two-way radios. Additionally, the term is used in reference to transmitter and/or receiver devices in cable, laser or optical fiber systems. As used herein the term wireless communications refers to electromagnetic waves that carry the signal over part or all of the communication path, wherein the electromagnetic waves as used herein includes radio waves, microwaves, infrared, optical, ultraviolet, X-rays, and gamma-rays and combinations thereof.

Other examples include two-way radios (e.g., Amateur and Citizens Radio Service, business, marine, walkie-talkies and military communications), monitors (e.g., devices that are simplified radio transmitter/receiver units with limited range), satellite communications, modems, cellular modems, cellular phones, and laser communications.

Additionally, a signal repeater may be used to increase the distance between the remote monitoring station and the surveillance unit, e.g., the signal repeater receives the signal from the remote monitoring unit and transmits the signal to the surveillance unit and vise versa. In addition, multiple repeaters may be linked together increasing the distance covered.

The surveillance apparatus of the present is in communication with a remote central monitoring unit. The communication between the communication unit of the surveillance apparatus and the remote central monitoring unit may be used to perform a variety of functions. The acquired data may be transferred from the surveillance apparatus to the remote central monitoring unit. The communication may be used to alter or adjust parameter of the operation of the surveillance apparatus, e.g., turn off or on sensors, microphones, speakers, lights, detection modules, activate battery power, activate solar power, switch between sensors or detection modules, reboot the system and the like. The communication may use a variety of transmission protocols that are known to persons of ordinary skill in the art. In some instances, the protocols may be encrypted to supply additional security for certain applications.

The surveillance apparatus of the present invention includes a power module, which is used to power the apparatus. The power module may use a battery alone or in conjunction with a solar cell or an array of solar cells or solar panels. The apparatus may be configured to operate using the battery at night or in times of low light and the solar panel when possible. Alternatively, the apparatus may be configured to operate off the battery, which will be recharged by the solar panel when possible. In other configurations different components may be configured to operate off of different sources, e.g., solar power for the communication unit and battery for the detection module.

The present invention also provides a surveillance apparatus including a communication unit, configured to collect data and configured for communications with a remotely located central monitoring unit that is operably connected to a capture module. The communication unit includes a receiver/processor unit and transmitter unit configured for communications with a remotely located central monitoring unit. The receiver/processor unit and transmitter unit include a circuit board connected to a transceiver unit that communicates with a transmission/reception device of the central monitoring unit. The circuit board has a plurality of connections for the transceiver unit and one or more of the following: a power supply, inputs from a detection monitor, inputs from a sensor, relay contacts for sending and receiving on/off commands to and from the central monitoring unit, a capture module, a battery voltage sensor, a battery, one or more analog input channel, one or more digital input channel, a camera, a microphone, a speaker unit and a flashlight, a detection monitor linked to the capture module allowing the activation of the detection monitor to activate the capture module, and a power module connected to the communication unit. The communication unit may include a modem a RF modem, a satellite modem, a broadband modem, a laser communication device, a RF communication device; a RF-ID communication device; an IR communication device or combinations thereof.

The surveillance apparatus of the present invention includes a communication unit that is in communication with a remote central monitoring unit. The communication between the communication unit of the surveillance apparatus and the remote central monitoring unit may be established in a variety of manners and may use transmission protocols that are known to persons of ordinary skill in the art. In some instances, the protocols may be encrypted to supply additional security for certain applications. The method of communication may be through a wireless modem, e.g., a wireless modem, a RF modem, a satellite modem, a broadband modem. The communications unit may also incorporate an identification code or stamp (ID stamp) into the signal to indicate a specific time, date or surveillance apparatus. The ID stamp will allow identification of individual surveillance apparatus connected on a network. The ID stamping may also be accomplished using a modem having a RF-ID communication device. Other methods of communication may be used to link the remote surveillance apparatus with the remote central monitoring unit, e.g., laser communication modules, IR communication modules ultrahigh frequency modules, microwave communications and the like. Additionally, the communications unit may include a combination of the above-mentioned modems and other communication devices known to persons of skill in the art.

In addition, a signal repeater may be used to increase the distance between the remote monitoring station and the surveillance unit, e.g., the signal repeater receives the signal from the remote monitoring unit and transmits the signal to the surveillance unit and vise versa, e.g., there is a distance of 80 miles between the remote monitoring unit and the surveillance unit so a signal repeater is placed 40 miles between the remote monitoring station and the surveillance unit allowing wireless communication between the remote monitoring station and the surveillance unit. Additionally, multiple repeaters may be linked together increasing the distance covered.

The surveillance apparatus of the present is in communication with a remote central monitoring unit. The communication between the communication unit of the surveillance apparatus and the remote central monitoring unit may be used to perform a variety of functions. The acquired data may be transferred from the surveillance apparatus to the remote central monitoring unit. The communication may be used to alter or adjust parameter of the operation of the surveillance apparatus, e.g., turn off or on sensors, microphones, speakers, lights, detection modules, activate battery power, activate solar power, switch between sensors or detection modules, reboot the system and the like or combinations thereof. The communication may use a variety of transmission protocols that are known to persons of ordinary skill in the art. In some instances, the protocols may be encrypted to supply additional security for certain applications.

The surveillance apparatus of the present invention is configured to collect data in response to activation. The data may be collected in a variety of formats depending on the type of capture module used. In one embodiment, the capture module may be a digital camera used as the capture module allowing the collection of the data on a multimedia format, e.g., rewriteable storage media, magnetic storage media and the like. A still photographic camera of any of the formats available may also be used, allowing the collected data to be in the form of a negative or photograph. Other capture modules may be used such as an analog camera, an IR camera, a night vision camera, a microphone allowing storage in the appropriate format for the type of detection module. Additionally combinations of the different capture module may be used as needed by the user for a specific application.

The capture module may include internal or external detection module that may be configured to detect any type of event the user wishes to monitor. The detection module may be a simple motion detector, detecting movement in the surrounding area or a more sophisticated detector able to discriminate based on degree of movement or size of the animal moving. Additionally, other types of detectors may be used. For example, detector modules may be configured to detect the heat emitted by an animal or object and adjusted to activate the collection of data when a certain level of heat emissions is reached, e.g., the heat emitted by a rat as opposed to that of a deer or a car. The detector modules may also be configured to detect light or sound allowing the collection of data in response to lights being turned on or off, the lights or sound of an automobiles arriving or departing, the sound of animals or people at the monitoring site. Additionally, detection module may be used observing the effects of environmental conditions at the remote location by the activation of the system when certain conditions are met like specific temperatures, wind speeds, rainfall, or humidity levels. The above-mentioned detection module may be combined in a variety of combinations as needed by the user for a particular situation. Typical methods known to those of skill in the art may be used in the detection module such as a photoelectric beam, an infrared beam, a laser beam, a microwave beam, a visible light beam, a UV beam, motion or combinations thereof.

The surveillance apparatus of the present invention may also include a power module, which is used to power the apparatus. The power module may include a battery alone or in conjunction with a solar cell or an array of solar cells or solar panels. The apparatus may be configured to operate using the battery at night or in times of low light and the solar panel when possible. Alternatively, the apparatus may be configured to operate off the battery, which will be recharged by the solar panel when possible. In other configurations, different components may be configured to operate off of different sources, e.g., solar power for the communication unit and battery for the detection module.

The present invention provides a surveillance network that includes two or more surveillance units, each of the two or more surveillance units individually having a capture module configured to collect data, a communication unit having a unique identification code, operably connected to the capture module and configured for communications with a remote central monitoring unit and a power module connected to the communication unit and the central monitoring unit remotely located from the two or more surveillance units, wherein the central monitoring unit communicates and exchanges data with each of the two or more surveillance units.

Each of the surveillance units include a capture module, which may include an internal or external detection module, which may be configured to detect any type of event the user wishes to monitor. The detection module may be a simple motion detector, detecting movement in the surrounding area or a more sophisticated detector able to discriminate based on degree of movement or size of the animal moving. Additionally, other types of detectors may be used. For example, detector modules may be configured to detect the heat emitted by an animal or object and adjusted to activate the collection of data when a certain level of heat emissions is reached, e.g., the heat emitted by a rat as opposed to that of a deer or a car. The detector modules may also be configured to detect light or sound allowing the collection of data in response to lights being turned on or off, the lights or sound of animal calls, automobiles arriving or departing, the sound of animals or people at the monitoring site. Additionally, detection module may be used to activate the system when certain conditions are met like specific temperatures, wind speeds, rainfall, or humidity levels, e.g., observing the effects of environmental conditions at the remote location. The above-mentioned detection module may be combined in a variety of combinations as needed by the user for a particular situation. Typical methods known to those of skill in the art may be used in the detection module such as a photoelectric beam, an infrared beam, a laser beam, a microwave beam, a visible light beam, a UV beam, motion or combinations thereof.

The surveillance network provided for by the present invention includes a communication unit incorporated into each surveillance units for communication with a remote central monitoring unit. The communication between the communication unit of the surveillance apparatus and the remote central monitoring unit may be established in a variety of manners and may use transmission protocols that are known to persons of ordinary skill in the art. In some instances, the protocols may be encrypted to supply additional security for certain applications. The method of communication may be through a wireless modem, e.g., a wireless modem, a RF modem, a satellite modem, a broadband modem. The communications unit may also incorporate an identification code or stamp (ID stamp) into the signal to indicate a specific time, date or surveillance unit. The ID stamp will allow identification of individual surveillance apparatus connected on a network. The ID stamping may also be accomplished using a modem having a RF-ID communication device. Other methods of communication may be used to link the remote surveillance apparatus with the remote central monitoring unit, e.g., laser communication modules, IR communication modules ultrahigh frequency modules, microwave communications and the like. Additionally, the communications unit may include a combination of the above-mentioned modems and other communication devices known to persons of skill in the art.

In addition, the effective coverage of the network may be increased through the addition of one or more signal repeaters used to increase the distance between the remote central monitoring station and the surveillance unit, e.g., the signal repeater receives the signal from the remote central monitoring unit and transmits the signal to the surveillance unit and vise versa. Additionally, multiple repeaters may be linked together increasing the distance covered.

Each surveillance unit of the surveillance network is in communication with a remote central monitoring unit. The communication between the communication unit of the surveillance unit and the remote central monitoring unit may be used to perform a variety of functions. The acquired data may be transferred from the surveillance apparatus to the remote central monitoring unit. The communication may be used to alter or adjust parameter of the operation of the surveillance apparatus, e.g., turn off or on sensors, microphones, speakers, lights, detection modules, activate battery power, activate solar power, switch between sensors or detection modules, reboot the system and the like. The communication may use a variety of transmission protocols that are known to persons of ordinary skill in the art. In some instances, the protocols may be encrypted to supply additional security for certain applications.

The surveillance unit of the surveillance network of the present invention includes a power module that supplies operational power. The power module may use a battery alone or in conjunction with a solar cell or an array of solar cells or solar panels. The apparatus may be configured to operate using the battery at night or in times of low light and the solar panel when possible. Alternatively, the apparatus may be configured to operate off the battery, which will be recharged by the solar panel when possible. In other configurations different components may be configured to operate off of different sources, e.g., solar power for the communication unit and battery for the detection module.

The surveillance network of the present invention includes a detector in each surveillance units that is configured to collect data in response to activation. The data may be collected in a variety of formats depending on the type of detection module used. In one embodiment, the detection module may be a still photographic camera of any of the formats available, allowing the collected data to be in the form of a negative or photograph. A digital camera may also be used as the detection module allowing the collection of the data on a multimedia format, e.g., rewriteable storage media, magnetic storage media and the like. Other detection module may also be used such as an analog camera, an IR camera, a night vision camera, a microphone allowing storage in the appropriate format for the type of detection module. Additionally combinations of the different detection module may be used as needed by the user for a specific application.

In accordance with the present invention a surveillance system including a sensor that monitors a parameter associated with the sensor, which is operable linked to a wireless communication module that communicates with a remote monitoring unit and electronically linked to a power control mechanism.

The sensor of the surveillance system may be configured to react to any type of parameter the user wishes to monitor. The sensor may be a simple motion detector, detecting movement in the surrounding area or a more sophisticated detector able to discriminate based on degree of movement or size of the animal moving. Additionally, other types of sensor may be used. For example, sensor modules may be configured to detect parameters such as the heat emitted by an animal or object and adjusted to activate the collection of data when a certain level of heat emissions is reached, e.g., the heat emitted by a rat as opposed to that of a deer or a car. The sensor modules may also be configured to detect parameters such as light or sound allowing the collection of data in response to lights being turned on or off, the lights or sound of an automobiles arriving or departing, the sound of animals or people at the monitoring site. Additionally, sensors may be used to observe the effects of environmental conditions at the remote location by the activation of the system when certain conditions are met like specific temperatures, wind speeds, rainfall, or humidity levels. The above-mentioned sensor may be combined in a variety of combinations as needed by the user for a particular situation and parameter to be observed. Typical methods known to those of skill in the art may be used in the sensor such as a photoelectric beam, an infrared beam, a laser beam, a microwave beam, a visible light beam, a UV beam, motion or combinations thereof.

The surveillance system of the present invention includes a wireless communication module that is in communication with a remote monitoring unit. The communication between the wireless communication unit of the surveillance system and the remote central unit may be established in a variety of manners and may use transmission protocols that are known to persons of ordinary skill in the art. In some instances, the protocols may be encrypted to supply additional security for certain applications. The method of communication may be through a wireless modem, e.g., a wireless modem, a RF modem, a satellite modem, a broadband modem. The communications module may also incorporate an identification code or stamp (ID stamp) into the signal to indicate a specific time, date or surveillance system. The ID stamp will allow identification of individual surveillance apparatus connected on the surveillance system. The ID stamping may also be accomplished using a modem having a RF-ID communication device. Other methods of communication may be used to link the remote surveillance system with the remote central monitoring unit, e.g., laser communication modules, IR communication modules ultrahigh frequency modules, microwave communications and the like. Additionally, the wireless communications module may include a combination of the above-mentioned modems and other communication devices known to persons of skill in the art.

The surveillance system of the present is in communication with a remote monitoring unit. The communication between the wireless communication unit of the surveillance system and the remote monitoring unit may be used to perform a variety of functions. The acquired data may be transferred from the surveillance system to the remote monitoring unit. The communication may be used to alter or adjust parameter of the operation of the surveillance system, e.g., turn off or on sensors, microphones, speakers, lights, detection modules, activate battery power, activate solar power, switch between sensors or detection modules, reboot the system and the like. The communication may use a variety of transmission protocols that are known to persons of ordinary skill in the art. In some instances, the protocols may be encrypted to supply additional security for certain applications.

The surveillance system of the present invention includes a power control mechanism, which is used as a source of power for the system. The power control mechanism may use a battery alone or in conjunction with a solar cell or an array of solar cells or solar panels. The surveillance system may be configured to operate using the battery at night or in times of low light and the solar panel when possible. Alternatively, the apparatus may be configured to operate off the battery, which will be recharged by the solar panel when possible. In other configurations, different components may be configured to operate off of different sources, e.g., solar power for the communication unit and battery for the sensor.

The present invention provides a method of performing surveillance including the steps of activating a surveillance component, capturing an image with a surveillance component, which has a wireless transmitter, transmitting the image to a wireless communication control unit remotely disposed with respect thereto, and processing the transmitted image.

The step of activating a surveillance component may be accomplished in a variety of ways. The surveillance components may be configured to detect the heat emitted by an animal or object and adjusted to activate the collection of data when a certain level of heat emissions is reached, e.g., the heat emitted by a rat as opposed to that of a deer or a car. The surveillance component may also be configured to detect light or sound allowing the collection of data in response to lights being turned on or off, the lights or sound of an automobiles arriving or departing, the sound of animals or people at the monitoring site. Additionally, surveillance component may be used to activate the system when certain conditions are met, like specific temperatures, wind speeds, rainfall, or humidity levels, e.g., observing the effects of environmental conditions at the remote location. The above-mentioned surveillance component may be combined in a variety of combinations as needed by the user for a particular situation. Typical methods known to those of skill in the art may be used in the detection module such as a photoelectric beam, an infrared beam, a laser beam, a microwave beam, a visible light beam, a UV beam, motion or combinations thereof. The surveillance component may be a simple motion detector, detecting movement in the surrounding area or a more sophisticated detector able to discriminate based on degree of movement or size of the animal moving.

The step of capturing an image with a surveillance component may use a variety of formats depending on the type of surveillance component used. In one embodiment, the surveillance component may be a still photographic camera of any of the formats available, allowing the collected data to be in the form of a negative or photograph. A digital camera may also be used as the surveillance component allowing the collection of the data on a multimedia format, e.g., rewriteable storage media, magnetic storage media and the like. Other surveillance component may also be used such as an analog camera, an IR camera, a night vision camera, a microphone allowing storage in the appropriate format for the type of detection module. Additionally combinations of the different surveillance component may be used as needed by the user for a specific application.

The surveillance component includes a wireless transmitter. In some embodiments, the wireless transmitter is a wireless modem. However, the wireless transmitter may be a RF modem, a satellite modem, a broadband modem. The wireless transmitter may also incorporate an identification code or stamp (ID stamp) into the signal to indicate a specific time, date or surveillance apparatus. The ID stamp will allow identification of individual surveillance apparatus connected on a network. The ID stamping may also be accomplished using a modem having a RF-ID communication device. Other methods of communication may be used to link the remote surveillance apparatus with the remote central monitoring unit, e.g., laser communication modules, IR communication modules ultrahigh frequency modules, microwave communications and the like. Additionally, the wireless transmitter may include a combination of the above-mentioned modems and other communication devices known to persons of skill in the art.

The step of transmitting the image to a wireless communication control unit is accomplished through the communication with the wireless communication control unit. The transmitting may be established in a variety of manners and may use transmission protocols that are known to persons of ordinary skill in the art. In some instances, the protocols may be encrypted to supply additional security for certain applications.

In addition to transmitting images, instructions may be transmitted to perform a variety of functions. The acquired images may be transferred from the surveillance component to the wireless communication control unit. The communication may be used to alter or adjust parameter of the operation of the surveillance component, e.g., turn off or on sensors, microphones, speakers, lights, detection modules, activate battery power, activate solar power, switch between components, reboot the system and the like. The transmitting may use a variety of transmission protocols that are known to persons of ordinary skill in the art

The step of processing the transmitted image generally includes displaying the image. However, the processing may include previewing the image, deleting the image, storing, writing the image to a CD, DVD, magnetic storage unit or the like.

The present invention also provide a surveillance apparatus including a communication unit operable connected to a capture module configured to collect data, wherein the communication unit includes a receiver/processor unit and transmitter unit configured for communications with a remotely located central monitoring unit, wherein the receiver/processor unit and transmitter unit includes a circuit board connected to a transceiver unit communicating with a transmission/reception device of the central monitoring unit, the circuit board comprising a plurality of connections for the transceiver unit and one or more of: a power supply, inputs from a detection monitor, inputs from a sensor, relay contacts for sending and receiving on/off commands to and from the central monitoring unit, a capture module, a battery voltage sensor, a battery, one or more analog input channel, one or more digital input channel, a camera, a microphone, a speaker unit and a flashlight, a detection monitor linked to the capture module, whereby activation of the detection monitor activated the capture module and a power module connected to the communication unit, wherein the communication unit includes a modem a RF modem, a satellite modem, a broadband modem, a laser communication device, a RF communication device or combinations thereof.

The circuit board of the surveillance apparatus may also include a CPU either integrated into the surveillance apparatus or as an additional component. The surveillance apparatus may use a CPU-equipped PC board. The CPU-equipped PC board may be configured for use in a PC and interacting with software (e.g., installed on the PC, installed on a electronic media, transmitted to the CPU-equipped PC board or combinations thereof. Other embodiments of the surveillance apparatus may include a complete computer operably linked thereto.

The detection monitor may be configured to detect any type of event the user wishes to monitor. The detection monitor may be a simple motion detector, detecting movement in the surrounding area or a more sophisticated detector able to discriminate based on degree of movement or size of the animal moving. Additionally, other types of detectors may be used. For example, detection monitors may be configured to detect the heat emitted by an animal or object and adjusted to activate the collection of data when a certain level of heat emissions is reached, e.g., the heat emitted by a rat as opposed to that of a deer or a car. The detection monitors may also be configured to detect light or sound allowing the collection of data in response to lights being turned on or off, the lights or sound of an automobiles arriving or departing, the sound of animals or people at the monitoring site. Additionally, detection monitors may be activated as a result of effects of environmental conditions at the remote location by the activation of the system when certain conditions are met like specific temperatures, wind speeds, rain fall, or humidity levels. The above-mentioned detection monitors may be combined in a variety of combinations as needed by the user for a particular situation. Typical methods known to those of skill in the art may be used in the detection monitors such as a photo-electric beam, an infrared beam, a laser beam, a microwave beam, a visible light beam, a UV beam, motion or combinations thereof.

The capture module of the present invention is configured to collect data in response to activation. The data may be collected in a variety of formats depending on the type of detection module used. In one embodiment, the capture module may be a still photographic camera of any of the formats available, allowing the collected data to be in the form of a negative or photograph. A digital camera may also be used as the capture module allowing the collection of the data on a multimedia format, e.g., rewriteable storage media, magnetic storage media and the like. Other capture module may also be used such as an analog camera, an IR camera, a night vision camera, a microphone allowing storage in the appropriate format for the type of capture module. Additionally combinations of the different capture modules may be used as needed by the user for a specific application.

The surveillance apparatus of the present invention includes a communication unit that is in communication with a central monitoring unit. The communication between the communication unit of the surveillance apparatus and the central monitoring unit may be established in a variety of manners and may use transmission protocols that are known to persons of ordinary skill in the art. In some instances, the protocols may be encrypted to supply additional security for certain applications. The method of communication may be through a wireless modem, e.g., a wireless modem, a RF modem or a satellite modem, a broadband modem. The communications unit may also incorporate an identification code or stamp (ID stamp) into the signal to indicate a specific time, date or surveillance apparatus. The ID stamp will allow identification of individual surveillance apparatus connected on a network. The ID stamping may also be accomplished using a modem having a RF-ID communication device. Other methods of communication may be used to link the remote surveillance apparatus with the central monitoring unit, e.g., laser communication modules, IR communication modules ultrahigh frequency modules, microwave communications and the like. Additionally, the communications unit may include a combination of the above-mentioned modems and other communication devices known to persons of skill in the art.

The surveillance apparatus of the present invention includes a power supply, which is used to power the apparatus. The power supply may use a battery alone or in conjunction with a solar cell or an array of solar cells or solar panels. The surveillance apparatus may be configured to operate using the battery at night or in times of low light and the solar panel when possible. Alternatively, the apparatus may be configured to operate off the battery, which will be recharged by the solar panel when possible. In other configurations different components may be configured to operate off of different sources, e.g., solar power for the communication unit and battery for the capture module.

Another example of the present invention provides a remote communication surveillance apparatus that may be linked to a preexisting surveillance system. The present invention includes a communication unit adapted to connect to a detection monitor, wherein the communication unit is configured for communication and exchange of data with a central monitoring unit, a sensor linked to the detection monitor, whereby activation of the sensor activated the detection monitor and a power module connected to the communication unit.

The remote communication surveillance apparatus of the present invention includes a communication unit designed to connect to a detection monitor. The detection monitor may be a still photographic camera of any of the formats available, allowing the collected data to be in the form of a negative or photograph. A digital camera may also be used as the detection monitor allowing the collection of the data on a multimedia format, e.g., rewriteable storage media, magnetic storage media and the like. Other detection monitors may also be used such as an analog camera, an IR camera, a night vision camera and a microphone allowing storage in the appropriate format for the type of detection module. Additionally, combinations of the different detection monitor may be connected as needed by the user for a specific application.

The communication between the communication unit of the surveillance apparatus and the central monitoring unit may be established in a variety of manners and may use transmission protocols that are known to persons of ordinary skill in the art. In some instances, the protocols may be encrypted to supply additional security for certain applications. The method of communication may be through a wireless modem, e.g., a wireless modem, a RF modem, a satellite modem and a broadband modem. The communications unit may also incorporate an identification code or stamp (ID stamp) into the signal to indicate a specific time, date or surveillance apparatus. The ID stamp will allow identification of individual surveillance apparatus connected on a network. The ID stamping may also be accomplished using a modem having a RF-ID communication device. Other methods of communication may be used to link the remote surveillance apparatus with the remote central monitoring unit, e.g., laser communication modules, IR communication modules ultrahigh frequency modules, microwave communications and the like. Additionally, the communications unit may include a combination of the above-mentioned modems and other communication devices known to persons of skill in the art.

The remote communication surveillance apparatus of the present is in communication with a remote central monitoring unit. The communication between the communication unit of the remote communication surveillance apparatus and the central monitoring unit may be used to perform a variety of functions. The acquired data may be transferred from the remote communication surveillance apparatus to the central monitoring unit. The communication may be used to alter or adjust parameter of the operation of the remote communication surveillance apparatus, e.g., turn off or on sensors, microphones, speakers, lights, detection modules, activate battery power, activate solar power, switch between sensors or detection modules, reboot the system and the like. The communication may use a variety of transmission protocols that are known to persons of ordinary skill in the art. In some instances, the protocols may be encrypted to supply additional security for certain applications.

The sensor may be configured to detect any type of event the user wishes to monitor. The sensor may be a simple motion detector, detecting movement in the surrounding area or a more sophisticated sensor able to discriminate based on degree of movement or size of the animal moving. Additionally, other types of sensors may be used. For example, sensors may be configured to detect the heat emitted by an animal or object and adjusted to activate the collection of data when a certain level of heat emissions is reached, e.g., the heat emitted by a rat as opposed to that of a deer or a car. The sensors may also be configured to detect light or sound allowing the collection of data in response to lights being turned on or off, the lights or sound of an automobiles arriving or departing, the sound of animals or people at the monitoring site. Additionally, detection module may be used observing the effects of environmental conditions at the remote location by the activation of the system when certain conditions are met like specific temperatures, wind speeds, rainfall, or humidity levels. The above-mentioned detection module may be combined in a variety of combinations as needed by the user for a particular situation. Typical, methods known to those of skill in the art may be used in the detection module such as a photoelectric beam, an infrared beam, a laser beam, a microwave beam, a visible light beam, a UV beam, motion or combinations thereof.

The remote communication surveillance apparatus of the present invention includes a power module, which is used to power the remote communication surveillance apparatus. The power module may use a battery alone or in conjunction with a solar cell or an array of solar cells or solar panels. The remote communication surveillance apparatus may be configured to operate using the battery at night or in times of low light and the solar panel when possible. Alternatively, the remote communication surveillance apparatus may be configured to operate off the battery, which will be recharged by the solar panel when possible. In other configurations different components may be configured to operate using different sources, e.g., solar power for the communication unit and battery for the detection module.

The present invention provides a method of automating surveillance including the steps of connecting a wireless transmitter to a single image event activated detection module configured to collect data and transmitting the data to a wireless communication control unit remotely disposed with respect thereto.

The wireless transmitter used in the method of automating surveillance is designed to communicate with the wireless communication control unit and the transmitting may be established in a variety of manners and may use transmission protocols that are known to persons of ordinary skill in the art. In some instances, the protocols may be encrypted to supply additional security for certain applications. The method of communication may be through a wireless modem, e.g., a wireless modem, a RF modem, a satellite modem, or a broadband modem. The wireless transmitter may also incorporate an identification code or stamp (ID stamp) into the signal to indicate a specific time, date or surveillance apparatus. The ID stamp will allow identification of individual surveillance apparatus connected on a network. The ID stamping may also be accomplished using a modem having a RF-ID communication device. Other methods of communication may be used, e.g., laser communication modules, IR communication modules ultrahigh frequency modules, microwave communications and the like. Additionally, wireless transmitter may include a combination of the above-mentioned modems and other communication devices known to persons of skill in the art.

The single image event activated detection module may be configured to detect any type of event the user wishes to monitor. The detection module may be a simple motion detector, detecting movement in the surrounding area or a more sophisticated detector able to discriminate based on degree of movement or size of the animal moving. Additionally, other types of detectors may be used. For example, detector modules may be configured to detect the heat emitted by an animal or object and adjusted to activate the collection of data when a certain level of heat emissions is reached, e.g., the heat emitted by a rat as opposed to that of a deer or a car. The detector modules may also be configured to detect light or sound allowing the collection of data in response to lights being turned on or off, the lights or sound of an automobiles arriving or departing, the sound of animals or people at the monitoring site. Additionally, detection module may be activated as a result of effects of environmental conditions at the remote location by the activation of the system when certain conditions are met like specific temperatures, wind speeds, rain fall, or humidity levels. The above mentioned detection module may be combined in a variety of combinations as needed by the user for a particular situation. Typical methods known to those of skill in the art may be used in the detection module such as a photo-electric beam, an infrared beam, a laser beam, a microwave beam, a visible light beam, a UV beam, motion or combinations thereof.

In accordance with the present invention, a surveillance apparatus including a communication unit operable connected to a capture module that is configured to collect data and configured for communications with a central monitoring unit, a detection monitor linked to the capture module, whereby activation of the detection monitor activated the capture module, a power module connected to the communication unit and a data base that tracks activation events by location and time.

For example, one embodiment of the present invention includes a surveillance system having a sensor that monitors external motion and operably connected to a digital camera. The surveillance system also contains a wireless communication module. The wireless communication module communicates with a cellular phone. The surveillance system is attached to a power control mechanism. Optionally, the surveillance system may be connected to a solar power supply to supply external power.

The surveillance apparatus of the present invention includes a communication unit that is in communication with a central monitoring unit. The communication between the communication unit of the surveillance apparatus and the central monitoring unit may be established in a variety of manners and may use transmission protocols that are known to persons of ordinary skill in the art. In some instances, the protocols may be encrypted to supply additional security for certain applications. The method of communication may be through a wireless modem, e.g., a wireless modem, a RF modem, a satellite modem, a broadband modem. The communications unit may also incorporate an identification code or stamp into the signal to indicate a specific time, date or surveillance apparatus. The ID stamp will allow identification of individual surveillance apparatus connected on a network. The ID stamping may also be accomplished using a modem having a RF-ID communication device. Additionally, the communications unit may include a combination of the above-mentioned modems and other communication devices known to persons of skill in the art.

The surveillance apparatus of the present is in communication with a central monitoring unit. The communication between the communication unit of the surveillance apparatus and the central monitoring unit may be used to perform a variety of functions. The acquired data may be transferred from the surveillance apparatus to the central monitoring unit. The communication may be used to alter or adjust parameter of the operation of the surveillance apparatus, e.g., turn off or on sensors, microphones, speakers, lights, detection modules, activate battery power, activate solar power, switch between sensors or detection modules, reboot the system and the like. The communication may use a variety of transmission protocols that are known to persons of ordinary skill in the art. In some instances, the protocols may be encrypted to supply additional security for certain applications.

The detection monitor may be configured to detect any type of event the user wishes to monitor. The detection monitors may be a simple motion detector, detecting movement in the surrounding area or a more sophisticated detector able to discriminate based on degree of movement or size of the animal moving. Additionally, other types of detection monitor may be used. For example, detection monitor may be configured to detect the heat emitted by an animal or object and adjusted to activate the collection of data when a certain level of heat emissions is reached, e.g., the heat emitted by a rat as opposed to that of a deer or a car. The detection monitor may also be configured to detect light or sound allowing the collection of data in response to lights being turned on or off, the lights or sound of an automobiles arriving or departing, the sound of animals or people at the monitoring site. Additionally, detection monitor may be activated as a result of an environmental condition at the remote location by the activation of the system when certain conditions are met like specific temperatures, wind speeds, rainfall, or humidity levels. The above mentioned detection monitor may be combined in a variety of combinations as needed by the user for a particular situation. Typical methods known to those of skill in the art may be used in the detection monitor such as a photo-electric beam, an infrared beam, a laser beam, a microwave beam, a visible light beam, a UV beam, motion or combinations thereof.

The surveillance apparatus of the present invention is configured to collect data in response to activation. The data may be collected in a variety of formats depending on the type of capture module used. In one embodiment, the capture module may be a still photographic camera of any of the formats available, allowing the collected data to be in the form of a negative or photograph. A digital camera may also be used as the capture module allowing the collection of the data on a multimedia format, e.g., rewriteable storage media, magnetic storage media and the like. Other capture modules may also be used such as an analog camera, an IR camera, a night vision camera, a microphone allowing storage in the appropriate format for the type of capture module. Additionally combinations of the different capture modules may be used as needed by the user for a specific application.

The surveillance apparatus of the present invention includes a power module, which is used to power the apparatus. The power module may use a battery alone or in conjunction with a solar cell or an array of solar cells or solar panels. The apparatus may be configured to operate using the battery at night or in times of low light and the solar panel when possible. Alternatively, the apparatus may be configured to operate off the battery, which will be recharged by the solar panel when possible. In other configurations, different components may be configured to operate off of different sources, e.g., solar power for the communication unit and battery for the capture module.

In addition, a signal repeater may be used to increase the distance between the remote monitoring station and the surveillance unit, e.g., the signal repeater receives the signal from the remote monitoring unit and transmits the signal to the surveillance unit and vise versa. Additionally, multiple repeaters may be linked together increasing the distance covered.

The present invention includes a surveillance system for remote locations having an enclosure with a motion sensor disposed within the enclosure. The motion sensor is operable to detect motion external to the enclosure. An image capture module is communicably coupled and activated by the motion sensor and a cellular communication module is operable linked to the capture module for transmitting one or more images obtained by the image capture module.

### BRIEF DESCRIPTION OF THE DRAWINGS

For a more complete understanding of the features and advantages of the present invention, reference is now made to the detailed description of the invention along with the accompanying figures and in which:

FIG. 1 illustrates a surveillance apparatus according to an embodiment of the present invention;

FIG. 2 illustrates a surveillance apparatus according to another embodiment of the present invention;

FIG. 3 is a illustrates a surveillance network 300 according to an embodiment of the present invention; and

FIG. 4 illustrates a surveillance network 400 according to an embodiment of the present invention.

### DETAILED DESCRIPTION OF THE INVENTION

While the making and using of various embodiments of the present invention may be discussed in detail below, it should be appreciated that the present invention provides many applicable inventive concepts that can be embodied in a wide variety of specific contexts. The specific embodiments discussed herein may be merely illustrative of specific ways to make and use the invention and do not delimit the scope of the invention.

To facilitate the understanding of this invention, a number of terms may be defined below. Terms defined herein have meanings as commonly understood by a person of ordinary skill in the areas relevant to the present invention. Terms such as “a”, “an” and “the” may be not intended to refer to only a singular entity, but include the general class of which a specific example may be used for illustration. The terminology herein is used to describe specific embodiments of the invention, but their usage does not delimit the invention, except as outlined in the claims.

As used herein, the present invention provides an apparatus, system and method of using remote surveillance apparatus having a data collection unit for recording data and a wireless communication module that is configured to communicate with a control unit that is located at a remote location.

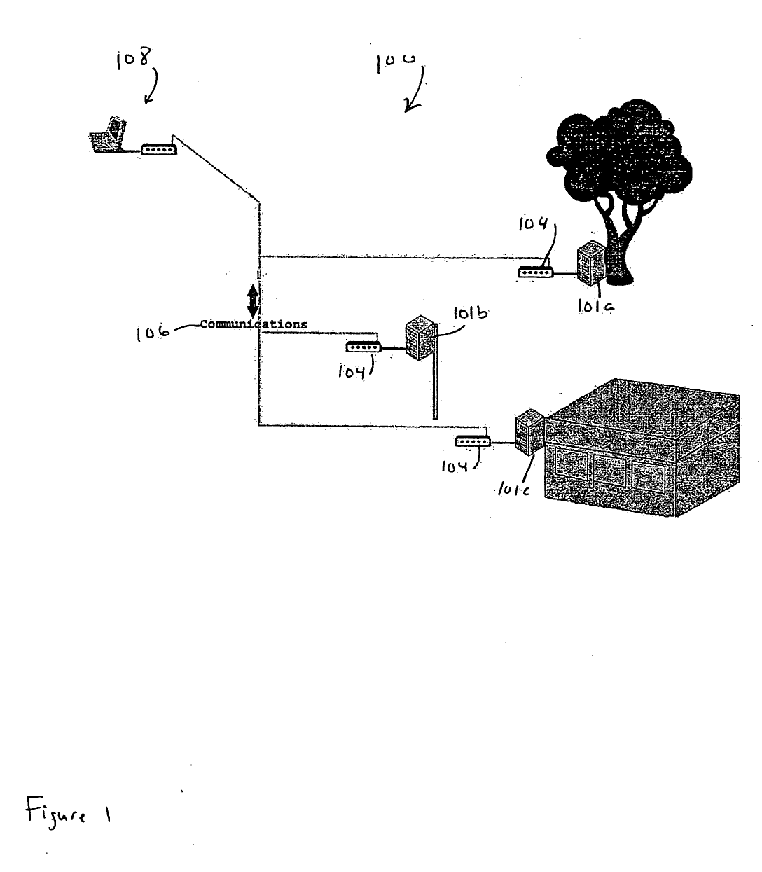

FIG. 1 illustrates a surveillance network 100 according to an embodiment of the present invention. The surveillance network 100 includes three surveillance units, e.g., 101a, 101b and 101c, each of the three surveillance units 101a, 101b and 101c individually having a capture module (not shown) configured to collect data, a communication unit 104 having a unique identification code operably connected (e.g., connected through wiring or wireless connections including UHF, IR, laser, digital or analog connections) to the capture module (not shown) and configured for communications 106 with a remote central monitoring unit 108 and a power module (not shown) connected to the communication unit 104 and the central monitoring unit 108 remotely located from the three surveillance units 101a, 101b and 101c, wherein the central monitoring unit 108 communicates 106 and exchanges data with each of the three surveillance units 101a, 101b and 101c.

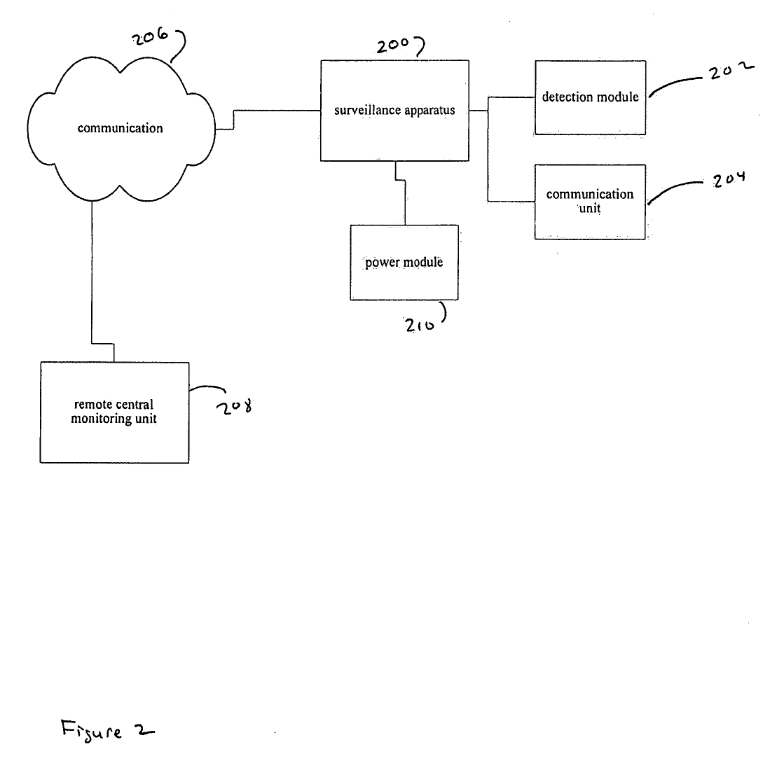

FIG. 2 illustrates a surveillance apparatus 200 according to an embodiment of the present invention. The present invention may use analog environments, digital environments or combinations thereof. One embodiment of the present invention includes a surveillance apparatus 200 for monitoring remote locations having a single image event activated detection module 202 configured to collect data and operably connected to a communication unit 204 that is in communication 206 with a remote central monitoring unit 208. The surveillance apparatus 200 also includes a power module 210 having a battery source in electrical communication with a solar panel for storage of energy generated by the solar panel, wherein the battery source independently powers the single image event activated detection module 202 and the communication unit 204. in certain embodiments the data may be transmitted as a burst of data, e.g., to prevent or reduce the possibility of triangulating the location of the apparatus.

The single image event activated detection module 202 may be configured to detect any type of event the user wishes to monitor. The detection module 202 may be a simple motion detector, detecting movement in the surrounding area or a more sophisticated detector able to discriminate based on degree of movement or size of the animal moving. Additionally, other types of detectors may be used. For example, detector modules 202 may be configured to detect the heat emitted by an animal or object and adjusted to activate the collection of data when a certain level of heat emissions is reached, e.g., the heat emitted by a rat as opposed to that of a deer or a car. The detector modules 202 may also be configured to detect light or sound allowing the collection of data in response to lights being turned on or off, the lights or sound of an automobiles arriving or departing, the sound of animals or people at the monitoring site. Additionally, detection modules 202 may be used to observe the effects of environmental conditions at the remote location by the activation of the system when certain conditions are met like specific temperatures, wind speeds, rainfall, or humidity levels. The above mentioned detection module 202 may be combined in a variety of combinations as needed by the user for a particular situation. Typical methods known to those of skill in the art may be used in the detection module 202 such as a photo-electric beam, an infrared beam, a laser beam, a microwave beam, a visible light beam, a UV beam, motion or combinations thereof.

The surveillance apparatus 200 of the present invention is configured to collect data in response to activation. The data may be collected in a variety of formats depending on the type of detection module 202 used. In one embodiment, the detection module 202 may be a still photographic camera of any of the formats available, allowing the collected data to be in the form of a negative or photograph. Although negative or photograph data are not the preferred form of data, the communication will provide an indication of activity at the location, indications of low resources, indications of malfunctions and combinations thereof. A digital camera may also be used as the detection module 202 allowing the collection of the data on a multimedia format, e.g., rewriteable storage media, magnetic storage media and the like. Other detection module 202 may also be used such as an analog camera, an IR camera, a night vision camera or a microphone, thus, allowing storage in the appropriate format for the type of detection module 202. Additionally combinations of the different detection module 202 may be used as needed by the user for a specific application.

The surveillance apparatus 200 of the present invention includes a communication unit 204 that is in communication 206 with a remote central monitoring unit 208. The communication 206 between the communication unit 204 of the surveillance apparatus 100 and the remote central monitoring unit 208 may be established in a variety of manners and may use transmission protocols that are known to persons of ordinary skill in the art. In some instances, the protocols may be encrypted to supply additional security for certain applications. The method of communication 206 may be through a wireless modem, e.g., a wireless modem, a RF modem, a satellite modem, a broadband modem. The communications unit may also incorporate an identification code or stamp (ID stamp) into the signal to indicate a specific time, date or surveillance apparatus. The ID stamp will allow identification of individual surveillance apparatus connected on a network. The ID stamping may also be accomplished using a modem having a RF-ID communication device. Other methods of communication may be used to link the remote surveillance apparatus 200 with the remote central monitoring unit 208, e.g., laser communication modules, IR communication modules ultrahigh frequency modules, microwave communications and the like. Additionally, the communications unit 104 may include a combination of the above-mentioned modems and other communication devices known to persons of skill in the art.

The surveillance apparatus 200 of the present is in communication with a remote central monitoring unit 208. The communication 206 between the communication unit 204 of the surveillance apparatus 200 and the remote central monitoring unit 208 may be used to perform a variety of functions. The acquired data may be transferred from the surveillance apparatus 200 to the remote central monitoring unit 208. The communication 206 may be used to alter or adjust parameter of the operation of the surveillance apparatus 200, e.g., turn off or on sensors, microphones, speakers, lights, detection modules, activate battery power, activate solar power, switch between sensors or detection modules, reboot the system and the like. The communication 206 may use a variety of transmission protocols that are known to persons of ordinary skill in the art. In some instances, the protocols may be encrypted to supply additional security for certain applications.

The surveillance apparatus 200 of the present invention includes a power module 210, which is used to power the surveillance apparatus 200. The power module 210 may use a battery alone or in conjunction with a solar cell or an array of solar cells or solar panels. The apparatus may be configured to operate using the battery at night or in times of low light and the solar panel when possible. Alternatively, the surveillance apparatus 200 may be configured to operate off the battery, which will be recharged by the solar panel when possible. In other configurations different components may be configured to operate off of different sources, e.g., solar power for the communication unit 204 and battery for the detection module 202.

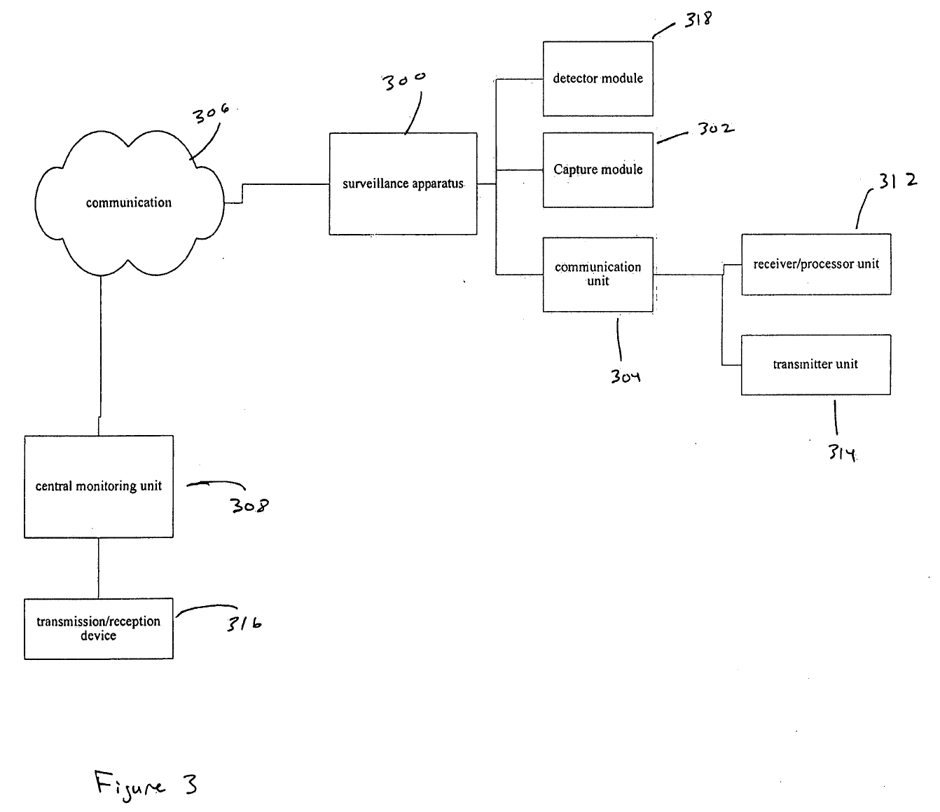

FIG. 3 illustrates a surveillance apparatus 300 according to another embodiment of the present invention. The surveillance apparatus 300 including a communication unit 304 is operable connected to a capture module 302, configured to collect data and configured for communications 306 with a remotely located central monitoring unit 308. The communication unit 304 includes a receiver/processor unit 312 and transmitter unit 314 configured for communications 306 with a remotely located central monitoring unit 308. The receiver/processor unit 312 and transmitter unit 314 include a circuit board (not shown) connected to a transceiver unit (not shown) that communicates with a transmission/reception device 316 of the central monitoring unit 308. The circuit board (not shown) has a plurality of connections for the transceiver unit and one or more of: a power supply, inputs from a detection monitor, inputs from a sensor, relay contacts for sending and receiving on/off commands to and from the central monitoring unit, a capture module, a battery voltage sensor, a battery, one or more analog input channel, one or more digital input channel, a camera, a microphone, a speaker unit and a flashlight, a detection monitor linked to the capture module allowing the activation of the detection monitor 318 to activate the capture module 302 and a power module 310 connected to the communication unit 304.

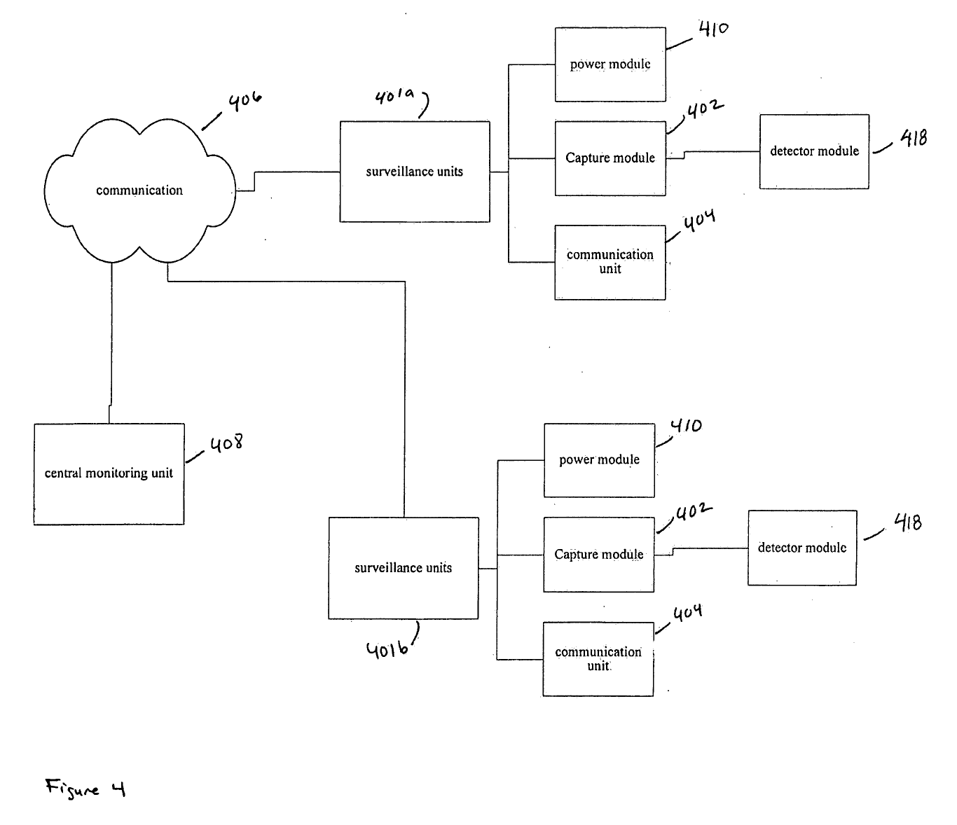

FIG. 4 illustrates a surveillance network 400 according to an embodiment of the present invention. Another example of the present invention is a surveillance network 400 that includes two or more surveillance units 401a and 401b, each of the two or more surveillance units 401a and 401b individually having a capture module 402 configured to collect data, a communication unit 404 having a unique identification code operably connected to the capture module 402 and configured for communications 406 with a remote central monitoring unit 408 and a power module 410 connected to the communication unit 404 and the central monitoring unit 408 remotely located from the two or more surveillance units 401a and 401b, wherein the central monitoring unit 408 communicates 406 and exchanges data with each of the two or more surveillance units 401a and 401b.

Each of the surveillance units 401a and 401b include a capture module 402, which may include an internal or external detection module 318, which may be configured to detect any type of event the user wishes to monitor. The detection module 418 may be a simple motion detector, detecting movement in the surrounding area or a more sophisticated detector able to discriminate based on degree of movement or size of the animal moving. Additionally, other types of detectors may be used. For example, detector modules 418 may be configured to detect the heat emitted by an animal or object and adjusted to activate the collection of data when a certain level of heat emissions is reached, e.g., the heat emitted by a rat as opposed to that of a deer or a car. The detector modules 318 may also be configured to detect light or sound allowing the collection of data in response to lights being turned on or off, the lights or sound of animal calls, automobiles arriving or departing, the sound of animals or people at the monitoring site. Additionally, detection module 418 may be used to activate the system when certain conditions are met like specific temperatures, wind speeds, rainfall, or humidity levels, e.g., observing the effects of environmental conditions at the remote location. The above mentioned detection module 418 may be combined in a variety of combinations as needed by the user for a particular situation. Typical methods known to those of skill in the are may be used in the detection module 418 such as a photo-electric beam, an infrared beam, a laser beam, a microwave beam, a visible light beam, a UV beam, motion or combinations thereof.

The surveillance network 400 provided for by the present invention includes a communication unit 404 incorporated into each surveillance units 401a and 401b for communication 406 with a remote central monitoring unit 408. The communication 406 between the communication unit 404 of the surveillance apparatus 401a and 401b and the remote central monitoring unit 408 may be established in a variety of manners and may use transmission protocols that are known to persons of ordinary skill in the art. In some instances, the protocols may be encrypted to supply additional security for certain applications. The method of communication may be through a wireless modem, e.g., a wireless modem, a RF modem, a satellite modem, a broadband modem. The communications unit may also incorporate an identification code or stamp (ID stamp) into the signal to indicate a specific time, date or surveillance unit. The ID stamp will allow identification of individual surveillance apparatus 401a and 401b connected on a network 400. The ID stamping may also be accomplished using a modem having a RF-ID communication device. Other methods of communication may be used to link the remote surveillance apparatus with the remote central monitoring unit, e.g., laser communication modules, IR communication modules ultrahigh frequency modules, microwave communications and the like. Additionally, the communications unit 404 may include a combination of the above-mentioned modems and other communication devices known to persons of skill in the art.

Each surveillance unit of the surveillance network 400 is in communication 306 with a remote central monitoring unit 408. The communication 406 between the communication unit 404 of the surveillance unit 401a and 401b and the remote central monitoring unit 408 may be used to perform a variety of functions. The acquired data may be transferred from the surveillance apparatus 401a and 401b to the remote central monitoring unit 408. The communication 406 may be used to alter or adjust parameter of the operation of the surveillance apparatus 401a and 401b, e.g., turn off or on sensors, microphones, speakers, lights, detection modules, activate battery power, activate solar power, switch between sensors or detection modules, reboot the system and the like. The communication may use a variety of transmission protocols that are known to persons of ordinary skill in the art. In some instances, the protocols may be encrypted to supply additional security for certain applications.

The surveillance unit 401a and 401b of the surveillance network 400 of the present invention includes a power module 410 that supplies operational power. The power module 410 may use a battery alone (not shown) or in conjunction with a solar cell (not shown) or an array of solar cells or solar panels (not shown). The surveillance unit 401a and 401b may be configured to operate using the battery at night or in times of low light and the solar panel when possible. Alternatively, the surveillance unit 401a and 401b may be configured to operate off the battery, which will be recharged by the solar panel when possible. In other configurations different components may be configured to operate off of different sources, e.g., solar power for the communication unit 404 and battery for the detection module 418.

The surveillance network 400 of the present invention includes a detection module 318 in each surveillance units 401a and 401b that is configured to collect data in response to activation. The data may be collected in a variety of formats depending on the type of detection module 418 used. In one embodiment, the detection module 418 may be a still photographic camera of any of the formats available, allowing the collected data to be in the form of a negative or photograph. A digital camera may also be used as the detection module 418 allowing the collection of the data on a multimedia format, e.g., rewriteable storage media, magnetic storage media and the like. Other detection module 418 may also be used such as an analog camera, an IR camera, a night vision camera, a microphone allowing storage in the appropriate format for the type of detection module 418. Additionally combinations of the different detection module may be used as needed by the user for a specific application.

It will be understood that particular embodiments described herein may be shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents may be considered to be within the scope of this invention and may be covered by the claims.

All publications and patent applications mentioned in the specification may be indicative of the level of skill of those skilled in the art to which this invention pertains. All publications and patent applications may be herein incorporated by reference to the same extent as if each individual publication or patent application was specifically and individually indicated to be incorporated by reference.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art, may be deemed to be within the spirit, scope and concept of the invention as defined by the appended claims.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification, but only by the claims.

What is claimed is:

1. A surveillance apparatus comprising:
a single image event activated detection module configured to collect data;
a communication unit operably connected to the detection module to communicate with a remote central monitoring unit; and
a power module comprising a battery source in electrical communication with a solar panel for storage of energy generated by the solar panel, the battery source independently powering the single image event activated detection module and the communication unit.

2. The apparatus of claim 1, wherein the communication unit comprises a cellular phone.

3. The apparatus of claim 1, wherein the remote central monitoring unit comprises a cellular phone.

4. The apparatus of claim 1, wherein the detection module detects heat, light, motion, temperature, sound, a photo-electric beam, an infrared beam, a laser beam, a microwave beam, a visible light beam, a UV beam, motion or combinations thereof.

5. The apparatus of claim 1, wherein the communication unit includes a modem, a RF modem, a satellite modem, a broadband modem, a laser communication device, a RF communication device, a RF-ID communication device, an IR communication device or combinations thereof.

6. The apparatus of claim 1, wherein the detection module is a still photographic camera, a digital camera, an analog camera, an IR camera, a night vision camera, a microphone or combinations thereof.

7. The apparatus of claim 1, wherein the communication unit includes a cellular phone, the detection module detects motion and the detection module is a digital camera.

8. A surveillance system comprising:
a sensor, wherein the sensor monitors a parameter associated with the sensor;
a capture module in communication with the sensor;
a wireless communication module operable linked to the sensor, wherein the wireless communication module communicates with a remote monitoring unit; and
a power control mechanism connected to the surveillance system.

9. The surveillance system of claim 8, wherein the detection module detects heat, light, motion, temperature, sound, a photo-electric beam, an infrared beam, a laser beam, a microwave beam, a visible light beam, a UV beam, motion or combinations thereof.

10. The surveillance system of claim 8, wherein the communication unit includes a modem a RF modem, a satellite modem, a broadband modem, a laser communication device, a RF communication device, a RF-ID communication device, an IR communication device or combinations thereof.

11. The surveillance system of claim 8, wherein the capture module is a still photographic camera, a digital camera, an analog camera, an IR camera, a night vision camera, a microphone or combinations thereof.

12. The surveillance system of claim 8, wherein the communication unit comprises a modem, and the detection module comprises a digital camera.

13. The surveillance system of claim 8, wherein the power control mechanism comprises a solar panel.

14. A method of performing surveillance comprising the steps of:
activating a surveillance component;
capturing an image with a surveillance component, wherein the surveillance component includes a wireless transmitter;
transmitting the image to a wireless communication control unit remotely disposed with respect thereto; and
processing the transmitted image.

15. The method of claim 14, wherein the step of activating a surveillance component includes the detection of heat, light, motion, temperature, sound or combinations thereof.

16. The method of claim 14, wherein the wireless transmitter includes a modem, a RF modem, a satellite modem, a broadband modem, a laser communication device, a RF communication device, a RF-ID communication device, an IR communication device or combinations thereof.

17. The method of claim 14, wherein the surveillance component is a still photographic camera, a digital camera, an analog camera, an IR camera, a night vision camera, a microphone or combinations thereof.

18. The method of claim 14, wherein the communication unit comprises a modem, the detection module detects motion and the detection module comprises a digital camera.

19. The method of claim 14, wherein the power control mechanism comprises a solar panel.

20. The method of claim 14, wherein the wireless communication control unit comprises a cellular phone.

21. A surveillance system for remote locations comprising:
an enclosure;
a motion sensor disposed within the enclosure and operable to detect motion external to the enclosure;
an image capture module communicably coupled and activated by the motion sensor; and
a cellular communication module operable linked to the capture module for transmitting one or more images obtained by the image capture module.
